(19) United States
(12) Patent Application Publication
(10) Pub. No.: US 2005/0156817 A1
(43) Pub. Date: Jul. 21, 2005

(54) Head-mounted display system and method for processing images

(75) Inventor: Yoichi Iba, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: OLYMPUS CORPORATION, Tokyo (JP)

(21) Appl. No.: 11/067,088

(22) Filed: Feb. 25, 2005

Related U.S. Application Data
(63) Continuation of application No. PCT/JP03/10615, filed on Aug. 22, 2003.

(30) Foreign Application Priority Data
Aug. 30, 2002 (JP) 2002-255695
Aug. 8, 2003 (JP) 2003-290853

(51) Int. Cl. G09G 5/00

(52) U.S. Cl. 345/8

(57) ABSTRACT

A head-mounted display system comprises: a display device freely detachable and attachable on a user's head; a direction detector for detecting the orientation of the user's head in at least the horizontal direction, the direction detector being disposed on the display device; an image generator for generating an image in accordance with the orientation of the user's head detected by the direction detector; a displacement-calculating unit for calculating displacement, the displacement being the difference between directional data of the current orientation of the user's head detected by the direction detector and directional data of the orientation of the user's head detected a predetermined amount of time ago; and an image processor for sending an image generated in the image generator to the display device after shifting the image in at least the horizontal direction in accordance with the displacement calculated by the displacement-calculating unit.

### CROSS REFERENCE TO RELATED APPLICATIONS

This application is a continuation application of PCT/JP2003/010615 filed on Aug. 22, 2003, and claims benefit of Japanese Application Nos. 2002-255695 filed in Japan on Aug. 30, 2002 and 2003-290853 filed in Japan on Aug. 8, 2003, the entire contents of each of which are incorporated herein by their reference.

### BACKGROUND OF THE INVENTION

1. Field of the Invention

The present invention relates to a head-mounted display system. More specifically, the invention relates to a head-mounted display system capable of displaying images in real time generated by an image generator based on the moving direction of a user's head without being affected by the processing time required for the arithmetic processing for generating the image, and also relates to a method for processing the images.

2. Description of the Related Art

Systems including a head-mounted display (HMD) have been receiving great amount of attention recently.

An HMD is a display worn on a user's head and is used as a visual display for virtual reality (VR) systems and mixed reality (MR) systems.

A typical VR or MR system includes an HMD having a head tracker (HT), which is a sensor for detecting the moving direction of the user's head, a controller for controlling an image display unit of the HMD, and a computer having image generating means for generating and outputting images to be displayed on the image display unit of the HMD and controlling means for controlling the entire system. The user wears this HMD on his or her head.

In such a system, the HT detects and measures the orientation of the user's head and outputs the results as directional data to the computer via the controller. The image generating means of the computer generates a virtual image based on the directional data by using computer graphics technology. In other words, the image generated by the image generating means is an image what a user would be seeing if he or she were to be standing in a virtual space. The computer outputs the generated image to the HMD via the controller. The HMD displays the image on its image display unit so that the user can view the image as a floating image.

In such a VR system, ideally, the process of measuring the direction of the user's head using the HT and displaying an image on the HMD must be performed instantaneously. In reality, however, arithmetic processing for generating an image, carried out by the computer, requires a predetermined amount of time (Δt). Therefore, even at the moment the user moves his or her head, the user's view in the virtual space via the HMD does not change, but, after a delay of Δt, the image changes in accordance with the change in the orientation of the user's head. Since this type of delay is not experienced in the real world, this delay causes the user to experience a sense of disorientation.

Similar technologies that have already been disclosed include Japanese Unexamined Patent Application Publication Nos. 9-284676 and 8-191419, for example.

Japanese Unexamined Patent Application Publication No. 9-284676 discloses a head-mounted display including a gyro-sensor. The disclosed head-mounted display is a graphic display apparatus including detecting means for detecting the moved amount and/or the rotated angle of a viewer's head. This head-mounted display is capable of processing an image such that part of an image signal of an original image is extracted and displayed in accordance with the moved amount and/or the rotated angle of the viewer's head.

Japanese Unexamined Patent Application Publication No. 8-191419 discloses a head-mounted display system that reads out an image to be viewed by a user from an image signal of a wide-view image, which is stored in a frame memory of a signal processor, based on the position information of the user's head detected by a rotational angle sensor.

### SUMMARY OF THE INVENTION

The head-mounted display system according to the present invention comprises: display means freely detachable and attachable on a user's head; direction-detecting means for detecting the orientation of a user's head in at least the horizontal direction, the direction-detecting means being disposed on the display means; an image generator for generating an image in accordance with the orientation of the user's head detected by the direction-detecting means; a displacement-calculating means for calculating displacement, the displacement being the difference between directional data of the current orientation of the user's head detected by the direction-detecting means and directional data of the orientation-of the user's head detected a predetermined amount of time ago; and image-processing means for sending an image generated at the image generator to the display means after shifting the image in at least the horizontal direction in accordance with the displacement calculated by the displacement-calculating means. According to this structure, the head-mounted display system according to the present invention can be produced at low cost and is capable of displaying an image, in real time, in accordance with the orientation of a user's head by reducing the time lag of image display caused by the arithmetic processing for generating an image.

### BRIEF DESCRIPTION OF THE DRAWINGS

FIG. 1 illustrates a first embodiment of a head-mounted display system according to the present invention and outlines the system configuration of the head-mounted display system;

FIG. 2 is a block diagram of the circuitry of the first embodiment of the head-mounted display system according to the present invention;

FIG. 3 is a schematic view illustrating the operating principle of the head-mounted display according to the present invention and illustrates a displacement in directional data due to a time lag Δt;

FIG. 4 is a schematic view illustrating the operating principle of the head-mounted display according to the present invention and illustrates a correction value Δθ for correcting the error in the directional signal due to the time lag Δt;

FIG. 5 is a schematic view illustrating the operating principle of the head-mounted display according to the present invention and is a graph illustrating the relationship between the correction value Δθ of FIG. 3 and t;

FIG. 6 is a schematic view illustrating the operating principle of the head-mounted display according to the present invention and illustrates the directional data for an image shifted in accordance with the correction value Δθ;

FIGS. 7A to 7E illustrates the operation of the head-mounted display according to the present invention, wherein FIG. 7A illustrates time, FIG. 7B illustrates the orientations of a user's head, FIG. 7C illustrates the correct images viewed by a user in accordance with an orientation of the user's head, FIG. 7D illustrates images generated and output by a computer, and FIG. 7E illustrates the corrected images displayed on the head-mounted display (HMD);

FIG. 8 illustrates a second embodiment of the head-mounted display according to the present invention and is a block diagram of the circuitry of the head-mounted display;

FIG. 9 illustrates a third embodiment of the head-mounted display according to the present invention and is a block diagram of the circuitry of the head-mounted display; and

FIG. 10 illustrates a fourth embodiment of the head-mounted display according to the present invention and is a block diagram of the circuitry of the head-mounted display;

### DESCRIPTION OF THE PREFERRED EMBODIMENTS

Embodiments of the present invention are described below with reference to the drawings.

### First Embodiment

(Configuration)

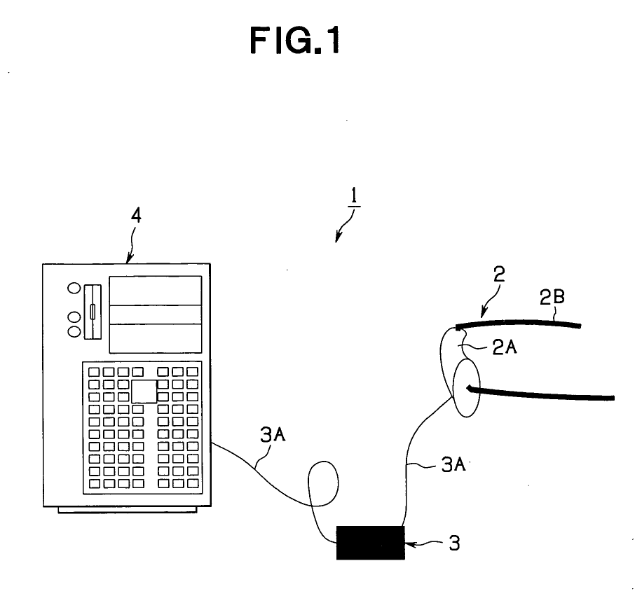

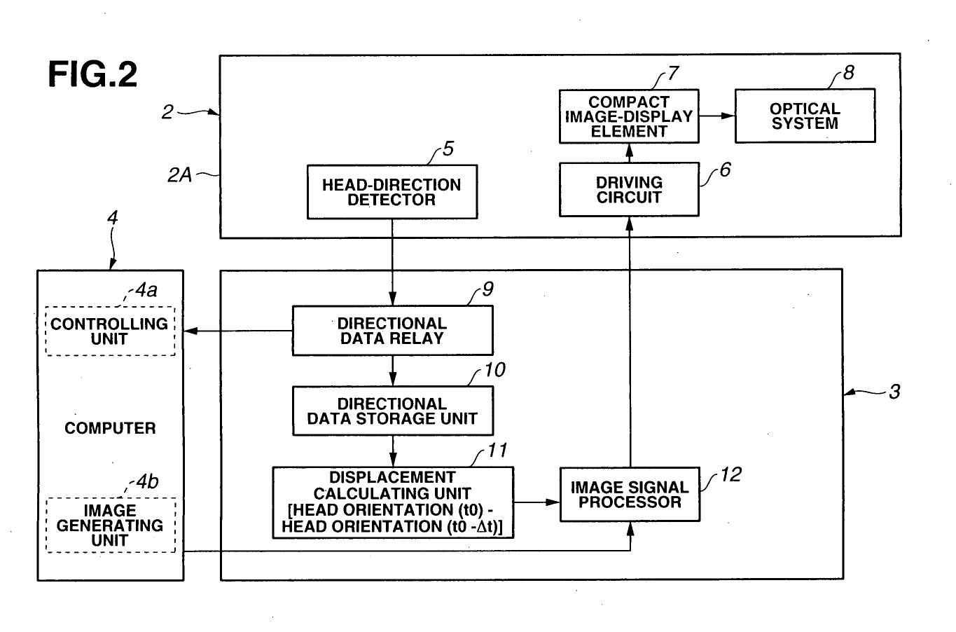

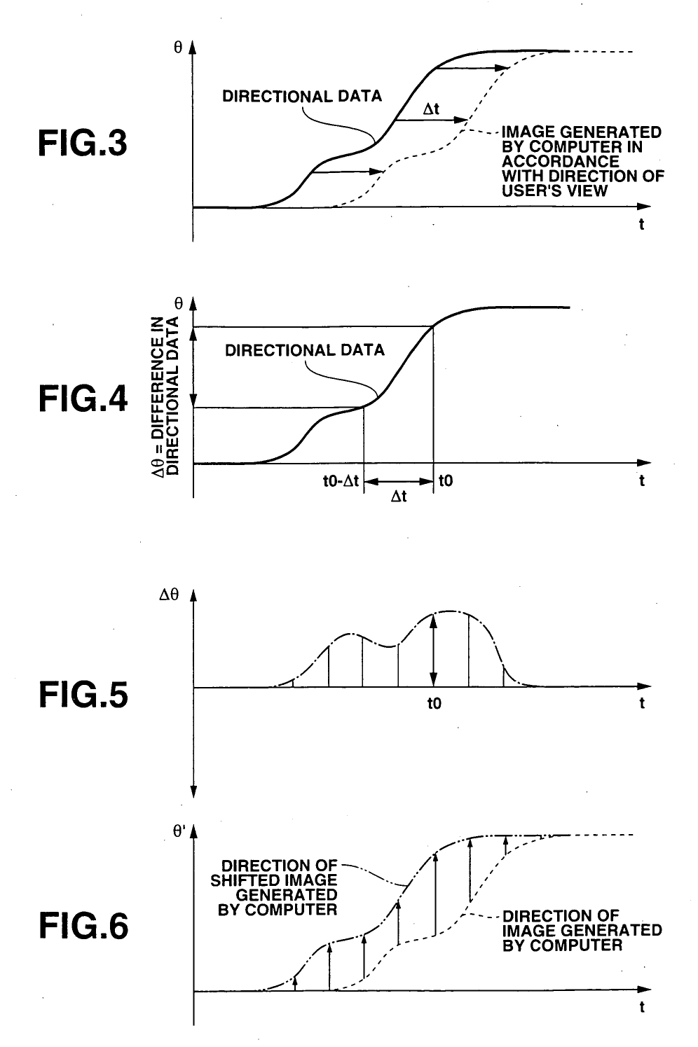

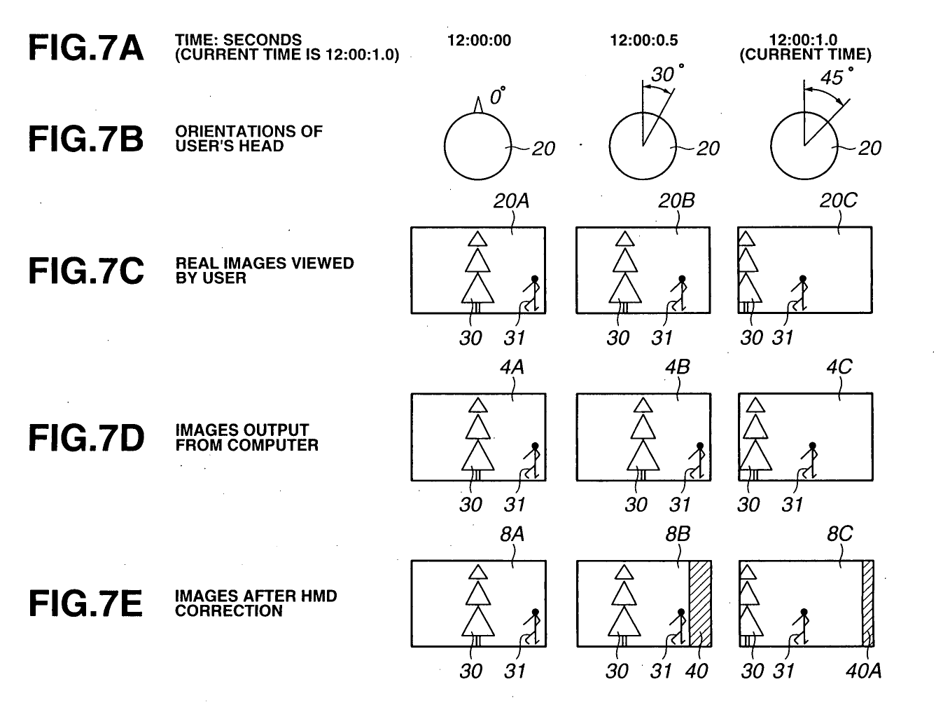

FIGS. 1 to 7 illustrate a first embodiment of the head-mounted display system according to the present invention. FIG. 1 illustrates the outline of the structure of the head-mounted display system. FIG. 2 is a block diagram illustrating the circuitry of the head-mounted display system. FIGS. 3 to 6 are schematic views illustrating the operating principle of the head-mounted display. FIG. 3 illustrates a displacement in directional data due to a time lag Δt. FIG. 4 illustrates a correction value Δθ for correcting the error due to the time lag Δt in the directional signal. FIG. 5 is a graph illustrating the correction value Δθ of FIG. 4 at time t. FIG. 6 illustrates the directional data for an image shifted in accordance with the correction value Δθ. FIGS. 7A to 7E illustrate the operation of the head-mounted display, wherein FIG. 7A illustrates time, FIG. 7B illustrates the orientations of a user's head, FIG. 7C illustrates the correct images viewed by a user in accordance with an orientation of the user's head, FIG. 7D illustrates images generated and output by a computer, and FIG. 7E illustrates the corrected images displayed on the head-mounted display (HMD).

The head-mounted display system according to the first embodiment has a simple structure in which known circuits are slightly modified. For this reason, the head-mounted display can be produced at a low cost. Moreover, the head-mounted display is capable of displaying images in accordance with the orientation of a user's head while reducing a delay in the display timing caused by the arithmetic processing for generating the image.

First, the principle of the head-mounted display system according to the present invention is described with reference to FIGS. 3 to 6. To simplify the description, it is assumed that the user's head only rotates around the vertical axis. In other words, the movement of the head is limited to the horizontal direction. The orientation of the head in the horizontal direction is represented by θ.

The head-mounted display system according to the present invention comprises at least head-direction detecting means, such as a head tracker (HT), for detecting the movement of a user's head, data storage means for storing (recording) information on the orientation of the head sent from the head-direction detecting means and information on a time lag Δt (where, the current time is t0) caused by the image generating process performed by a computer functioning as an image generator, displacement calculation means for calculating the displacement (or shift Δθ) of the head orientation during the time lag Δt, and image signal-processing means for correcting the image based on the obtained shift Δθ.

For a head-mounted display system having the above-described structure, a predetermined amount of time (Δt) is required for the computer to perform arithmetic processing for generating an image based on the orientation of the user's head. FIG. 3 illustrates this delay Δt. The solid line in FIG. 3 represents the directional data θ detected by the head-direction detecting means. The broken line in FIG. 3 represents the directional data generated by the computer functioning as an image generator based on the direction of the user's view (i.e., the orientation of the user's head). In this case, since the arithmetic processing for generating an image requires a predetermined amount of time (Δt), the broken line in FIG. 3 can be obtained by shifting the solid line to the right by Δt.

FIG. 4 illustrates how the correction value Δθ is derived from the direction detection signal (i.e., directional data) obtained by the head-direction detecting means. More specifically, the data storage means and the displacement calculation means are used to obtain the correction value Δθ by subtracting the directional data measured previously by Δt from the current directional data. FIG. 5 is a graph illustrating the obtained correction value Δθ. The correction value. Δθ indicated by an arrow in FIG. 4 is equivalent to the correction value Δθ at the current time to indicated by an arrow in FIG. 5. In this case, if the user does not move his or her head, the correction value Δθ is zero. If the user moves his or her head at a constant rate, the solid line in FIG. 4 becomes a straight line (instead of a curved line).

According to the present invention, the signal processing means used to correct the image generated by the computer is based on the obtained correction value Δθ. In this way, an image can be displayed on the head-mounted display in real time (i.e., without a delay) in accordance with the orientation of the user's head even though a predetermined amount of time (Δt) is required for the arithmetic processing for generating an image. FIG. 6 illustrates how the time lag Δt is compensated for. More specifically, FIG. 6 illustrates the directional data generated by the signal processing means of the computer based on the direction of the user's view (i.e., the orientation of the user's head). This image, represented by the double-dashed chain line in FIG. 6, is obtained by shifting the image generated at the image generator of the computer by Δθ. When FIGS. 3 and 6 are compared, it is apparent that the double-dashed chain line in FIG. 6 matches the solid line in FIG. 3. In other words, the orientation of the corrected image (FIG. 6) matches the orientation of the user's head detected by the detecting means (FIG. 3). As a result, the arithmetic processing for generating an image appears as though it has been carried out without any time lag.

In the case above, the displacement of the user's head is limited to the horizontal direction to simplify the description. When the user's head is moved freely in all directions, the orientation of the head is measured using a matrix instead of the scalar value θ. Similarly, Δθ may be represented using a transformation matrix. Since the sense of disorientation experienced by the user when there is a delay in the image display is severer in the horizontal direction compared to the vertical and rotational directions, the sense of disorientation is greatly reduced even when only corrections are made in the horizontal direction. It is advantageous to apply corrections only in the horizontal direction since the circuitry of the head-mounted display can be kept simple.

An embodiment of the head-mounted display system according to the present invention employing the above-described principle to solve the above-mentioned problems is described below.

As illustrated in FIG. 1, a head-mounted display system 1 according to a first embodiment of the present invention comprises a head-mounted display (HMD) 2 having a head-direction detecting means, a controller 3 for controlling an image display of the HMD 2 electrically connected to the HMD 2 via a connection cable 3A, and a computer 4 electrically connected to the controller 3 via the connection cable 3A and functioning as an image generator having an arithmetic processor for generating an image.

The HMD 2 comprises a main body 2A including components, such as an image display unit, and attachment units 2B for mounting the HMD 2 on a user's head. The attachment units 2B, such as arms, are attached to both ends of the main body 2A so that the main body 2A is mounted on the user's head to cover the user's eyes. The attachment unit 2B is not limited to the arms and may be any type of structure so long as the main body 2A can be mounted on the user's head. For example, the attachment unit 2B may be a helmet. Although not depicted in the drawing, the attachment units 2B include inner speakers for playing audio associated with the displayed image. These speakers are located at both positions corresponding to the user's ears.

The controller 3 is an HMD controller for controlling the image display unit (described below) of the HMD 2. The controller 3 controls the image displayed on the image display unit disposed on the main body 2A of the HMD 2, the sound volume, the image quality, the sound quality, and the on and off state of the power switch. The controller 3 also includes terminals required for connecting operating means (not depicted in the drawing) for the above-mentioned various controls and the connection cable 3A.

The computer 4 functions as an image generator having an arithmetic processor for generating an image (described below). The computer 4 generates and outputs an image based on the directional data corresponding to the orientation of the user's head detected by the head-direction detecting means of the HMD 2. For example, the computer 4 may be a game console capable of outputting a graphical image when the head-mounted display system 1 is used as a game apparatus.

Next, the electrical circuitry of the head-mounted display is described with reference to FIG. 2.

As illustrated in FIG. 2, inside the main body 2A of the HMD 2, a head-direction detecting unit 5, which is equivalent to the head-direction detecting means, a compact image-display element 7, a driving circuit 6 for driving the compact image-display element 7, and an optical system 8 for projecting a floating image are disposed.

The head-direction detecting unit 5 comprises a head tracker (HT) for detecting the movement of a user's head and outputs the detected directional data (i.e., directional vector) for the movement of the user's head to a directional data relay 9 of the controller 3.

The compact image-display element 7 comprises, for example, a liquid crystal display (LCD) for displaying the input data. The compact image-display element 7 is disposed on the inner surface of the main body 2A.

The driving circuit 6 drives and controls the compact image-display element 7 so as to display an image based on an input image signal on the compact image-display element 7.

The optical system 8 has a positive refracting power and is capable of forming the image displayed on the compact image-display element 7 as a realistic floating image for the user. Although not depicted in the drawing, a shield for preventing outside light from entering the optical system 8 and the compact image-display element 7 when the main body 2A of the HMD 2 is mounted on the user's head by the attachment units 2B is provided on the HMD 2.

The controller 3 includes the directional data relay 9, which receives directional data from the head-direction detecting unit 5 of the HMD 2 and outputs the directional data, a directional data storage unit 10 for storing directional data (including directional data with a time lag Δt caused by the image generation processing performed by the computer 4) from the directional data relay 9, a displacement calculation unit 11 for calculating the displacement (shift Δθ) of the user's head that has occurred during a predetermined amount of time (Δt), and an image signal processing unit 12 for correcting the image based on the obtained shift Δθ.

The directional data relay 9 outputs the received directional data to the directional data storage unit 10 and the computer 4.

The computer 4 comprises: a controlling unit 4a for controlling the various devices and the entire system; and an image generating unit 4b for generating an image based on the directional data. The image generating unit 4b generates a virtual image in accordance with the obtained directional data and outputs the image to the image signal processing unit 12 of the controller 3.

In the head-mounted display system 1 having the above-described structure, when directional data is sent from the head-direction detecting unit 5 of the HMD 2 to the directional data storage unit 10 via the directional data relay 9 of the controller 3, the directional data is stored in the directional data storage unit 10 of the controller 3.

The directional data storage unit 10 sends the most recently recorded directional data (i.e., directional data measured at the current time t0) and the already-recorded directional data measured Δt (time required for the image generating processing by the computer) ago to the displacement calculation unit 11.

The displacement calculation unit 11 calculates the difference between the current directional data and the already-recorded directional data measured Δt ago. Based on this difference, the displacement calculation unit 11 carries out arithmetic processing to calculate the shift in the vertical and horizontal directions caused by a time lag Δt due to the arithmetic processing carried out by the computer 4. The obtained shift is sent to the image signal processing unit 12. Then, the image signal processing unit 12 processes the image received from the image generating unit 4b of the computer 4 such that the image is inversely shifted in the vertical and horizontal directions by the same amount as the shift calculated in the displacement calculation unit 11. The inversely shifted image signal is outputted to the driving circuit 6 of the HMD 2.

The driving circuit 6 drives the compact image-display element 7 in accordance with the corrected image signal. In this way, it appears as though the computer 4 has instantaneously generated an image having the correct orientation. As a result, the user can view a virtual floating image through the optical system 8 without experiencing disorientation.

According to the first embodiment, the displacement calculation unit 11 carries out arithmetic processing to calculate the shift of the user's view in the vertical and horizontal directions caused by a time lag Δt due to the arithmetic processing of the computer 4. However, the displacement calculation unit 11 is not limited to performing arithmetic processing and may, instead, calculate the rotated amount of the user's viewing direction. Then, corrections for this rotated amount may be carried out by the image signal processing unit 12.

(Operation)

The operation of the head-mounted display system 1 according to the first embodiment will be described in detail with reference to FIG. 7.

As illustrated in FIGS. 7A and 7B, the time the head-mounted display system 1 starts operating (i.e. starting time t) is 12:00. The amount of time (Δt) required for the arithmetic processing carried out by the computer 4 is 0.5 seconds. The horizontal displacement of the user's head observed during a predetermined amount of time (Δt) after the starting time t is 30°. The horizontal displacement of the user's head observed during a predetermined amount of time (Δt×2) after the starting time t is 15°.

The user wears the head-mounted display system 1 on his or her head and turns on the power at 12:00.

As illustrated in FIG. 7B, the user's head 20 is directed frontward (0°) at 12:00. An image 20A, which is the real frontward view, is illustrated in FIG. 7C. The image 20A includes a person 31 standing on the right of a tree 30 located in the center. The output image from the computer 4 is an image 4A, illustrated in FIG. 7D, since the user's head has not moved. This image 4A is sent to the image signal processing unit 12 of the controller 3. As a result, the compact image-display element 7 of the HMD 2 displays an image 8A (refer to FIG. 7E), which is the same as the image 4A.

After 0.5 seconds (i.e. after the predetermined amount of time (Δt)) at 12:00.05, the user's head 20 moves 30° rightward. The real image viewed at 30° is an image 20B illustrated in FIG. 7C wherein the tree 30 and the person 31 have moved slightly leftward compared to the image 20A. However, the output image from the computer 4, as illustrated in FIG. 7D, is an image 4B that is substantially the same as the real image 20A viewed at 12:00, since a predetermined amount of time (Δt) is required for the arithmetic processing by the image generating unit 4b, and, thus, an image in accordance with the displacement of the user's head cannot be obtained at 12:00.05. Therefore, the image 4B is sent to the image signal processing unit 12 of the controller 3.

However, in the first embodiment, the displacement calculation unit 11 is used to obtain the difference between the current directional data and the directional data that has already been recorded a predetermined amount of time (Δt) ago. Based on this difference, the displacement calculation unit 11 carries out arithmetic processing to calculate the shift (refer to Δθ in FIG. 4 and a shift 40 illustrated in FIG. 7E) in the vertical and horizontal directions caused by a time lag Δt in the arithmetic processing by the computer 4. Then, the image signal processing unit 12 processes the image 4B received from the image generating unit 4b of the computer 4 such that the image is inversely shifted in the vertical and horizontal directions by the same amount as the shift calculated at the displacement calculation unit 11 (refer to FIG. 6). Since the inversely shifted image signal is sent to the driving circuit 6 of the HMD 2, the compact image-display element 7 displays an image 8B (refer to FIG. 7E) that is substantially the same as the real image. As a result, it appears as though the computer 4 has instantaneously generated an image corresponding to the orientation of the user's head.

Moreover, after another 0.5 seconds (at 12:00.10), the user's head 20 is moved rightwards to 45°. The real image viewed by the user at 45° is an image 20C illustrated in FIG. 7C, wherein the tree 30 is located at the far left and the person 31 is standing in the center. However, the output image from the computer 4, as illustrated in FIG. 7D, is an image 4C, which is substantially the same as the real image 20C (which is the same as the image 4C) viewed at 12:00.05, since a predetermined amount of time (Δt) is required for the arithmetic processing by the image generating unit 4b, and, thus, an image in accordance with the displacement of the head cannot be obtained at 12:00.10. Therefore, the image 4C is sent to the image signal processing unit 12 of the controller 3.

However, in the first embodiment, the displacement calculation unit 11 is used to obtain the difference between the current directional data and the directional data that has already been recorded a predetermined amount of time (Δt) ago. Based on this difference, the displacement calculation unit 11 carries out arithmetic processing to calculate the shift (refer to a shift 40A illustrated in FIG. 7E) in the vertical and horizontal directions caused by a time lag Δt caused by the arithmetic processing carried out by the computer 4. Then, the image signal processing unit 12 processes the image 4C received from the image generating unit 4b of the computer 4 such that the image is inversely shifted in the vertical and horizontal directions by the same amount as the shift calculated at the displacement calculation unit 11. Since the inversely shifted image signal is sent to the driving circuit 6 of the HMD 2, the compact image-display element 7 displays an image 8C (refer to FIG. 7E), which is substantially the same as the real image. As a result, it appears as though the computer 4 has instantaneously generated an image corresponding to the orientation of the user's head.

Consequently, the user can view and confirm by a virtual floating image through the optical system 8 without experiencing disorientation.

As illustrated in FIG. 7E, sometimes a region where an image is not displayed appears in the vicinity of the corrected image (indicated by the shaded area in the drawings). To prevent this region from appearing or to reduce the size of this region, a visual field mask for covering the peripheral area of the display region of the compact image-display element 7 may be disposed in front of the compact image-display element 7, as illustrated in FIG. 2.

Alternatively, by driving the compact image-display element 7 so that it is overscanned, the image based on the image signal will be displayed beyond the effective display region of the display element. In other words, an overscanned image having its peripheries cut off can be displayed on the display element.

(Advantages)

According to the first embodiment, a head-mounted display system 1 and a method capable of displaying, in real time, an image in accordance with the orientation of a user's head while minimizing the time lag in image display caused by the arithmetic processing for generating an image can be provided at low cost.

The above-mentioned time lag Δt differs according to the arithmetic processing capability of the computer in use. However, in the present invention, the image generating time (Δt) required for the computer may be measured in advance and manually input to the displacement calculation unit 11. If Δt is automatically input, the operation required by the user will be even more simplified. This kind of automatic input of Δt will be described below as a second embodiment of the present invention.

### Second Embodiment

(Configuration and Operation)

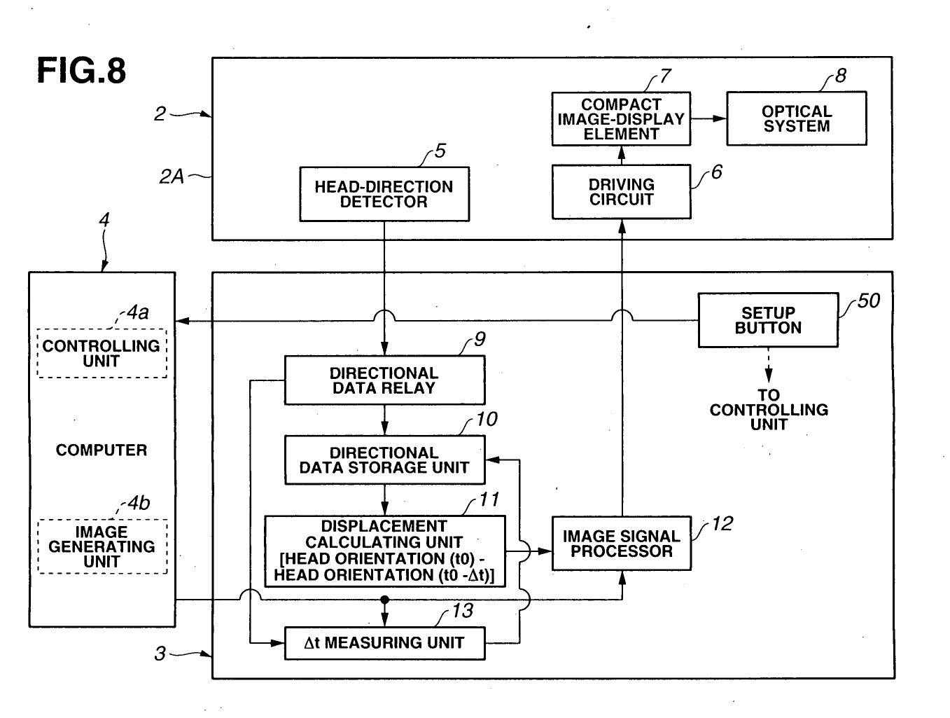

FIG. 8 illustrates a head-mounted display system according to a second embodiment of the present invention and is a block diagram of the circuitry of the head-mounted display system. The components included in FIG. 8 that are the same as those of the first embodiment are represented by the same reference numerals. Only descriptions for components that differ from the first embodiment are provided.

According to the second embodiment, a Δt measuring unit 13 and a setup button 50 for automatically inputting Δt are provided in the controller 3. Moreover, the directional data relay 9 has an additional function. Other structures are the same as the head-mounted display system according to the first embodiment.

As illustrated in FIG. 8, the setup button 50 of the controller 3 is an operational button for automatically measuring Δt. When the setup button 50 is pressed down, an operational signal is sent to the directional data relay 9 a controlling unit (not depicted in the drawing) for controlling the entire controller. In this case, the controlling unit controls the processing of the controller 3 according to the setup mode.

When the setup button 50 is pressed down, the directional data relay 9 outputs first directional data, which is dummy data, based on the received operational signal to the computer 4 and the Δt measuring unit 13. The directional data relay 9 outputs second directional data obtained by adding a predetermined displacement to the first directional data after a predetermined amount of time (for example, one second), which is longer than the assumed Δt, to the computer 4 and the Δt measuring unit 13.

An image generating unit 4b of the computer 4 generates a first image based on the first directional data and outputs this first image to the Δt measuring unit 13 and image signal processing unit 12 of the controller 3. At the same time, the image generating unit 4b of the computer 4 generates a second image based on the second directional data and outputs this second image to the Δt measuring unit 13 and image signal processing unit 12 of the controller 3.

The Δt measuring unit 13 starts counting time at the moment it receives the second directional data. When the Δt measuring unit 13 receives the second image, it stops counting time and counts the time so far. In other words, the Δt measuring unit 13 measures Δt, which equals the amount of time from the moment the directional data relay 9 sends data to the computer 4 to the moment the second image is sent to the controller 3. Then, the Δt measuring unit 13 outputs the measured Δt to the directional data storage unit 10.

To measure Δt by the Δt measuring unit 13, it is necessary to detect the moment when the image sent from the computer 4 changes from the first image to the second image. In this case, time differentiation is carried out from a brightness signal of the first and second image signals. The moment the results of the time differentiation change significantly is determined as the moment the first image has changed to the second image. Instead of applying time differentiation, the moment the first image changes to the second image may be detected by other means.

To measure Δt by the Δt measuring unit 13, an image pattern to be generated at the image generating unit 4b of the computer 4 may be recorded in the image generating unit 4b or other storage means. Then, Δt may be measured by outputting the first and second images to the Δt measuring unit 13 of the controller 3 based on this image pattern. According to such a Δt measuring method, Δt can be measured more accurately.

Furthermore, according to the second embodiment, the image pattern to be recorded in advance may be a plurality of images having different numbers of polygons. Then, Δt for each image may be measured. The average or the weighted average of Δt of the plurality of images may be used as Δt for the displacement calculation unit 11. In this way, the processing carried out by the head-mounted display system 1 will be highly accurate.

Other structures and operations of the second embodiment of the present invention are the same as the first embodiment.

(Advantages)

According to the second embodiment of the present invention, in addition to the advantages of the first embodiment, various values of Δt, which is the time required for carrying out the arithmetic processing for generating an image, for different computers may be set automatically so as to greatly simplify the operations that have to be carried out by the user.

The head-direction detecting unit 5 used for the head-mounted display system 1 according to the first and second embodiments may be an acceleration sensor or a magnetic sensor. An acceleration sensor is highly responsive but generates drift. On the other hand, a magnetic sensor does not generate drift, but is not very responsive.

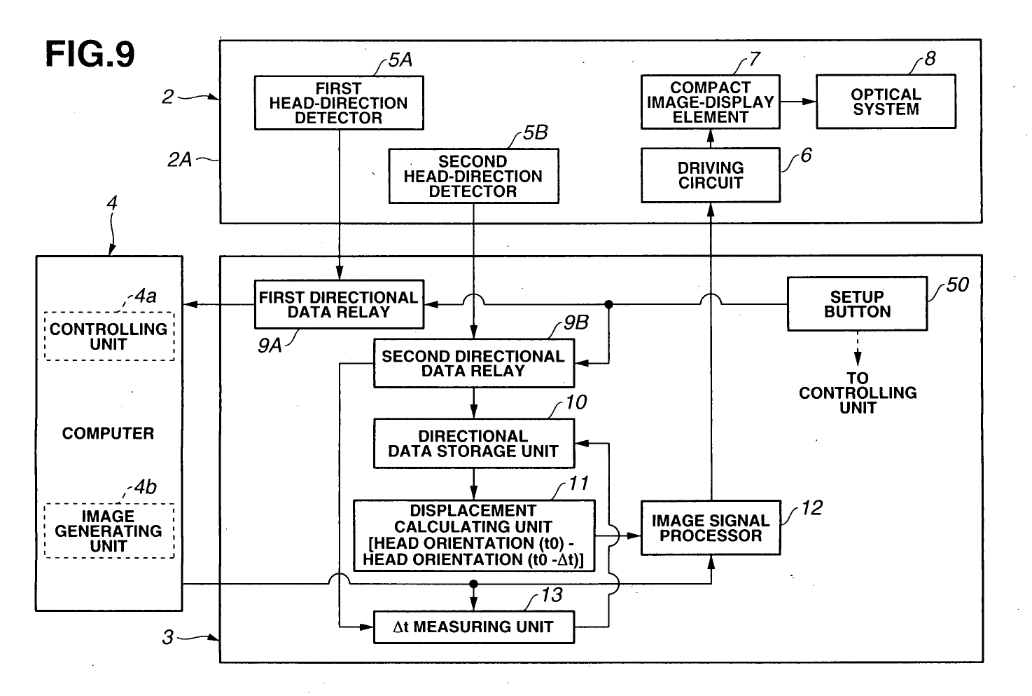

By using both an acceleration sensor and a magnetic sensor for the head-direction detecting unit 5, both sensors can be put to their best use. In this way, the disorientation experienced by the user may be reduced without using a costly head-direction detecting unit. Thus, the head-mounted display system 1 may be produced at low cost. This head-mounted display system 1 will be described below with reference to FIG. 9.

### Third Embodiment

(Configuration and Operation)

FIG. 9 illustrates a third embodiment of the head-mounted display 1 according to the present invention and is a block diagram of the circuitry of the head-mounted display. The components included in FIG. 9 that are the same as those in the second embodiment are represented by the same reference numerals.

The head-mounted display system 1 according to the third embodiment includes first and second head-direction detecting units 5A and 5B instead of the head-direction detecting unit 5 according to the second embodiment. Furthermore, first and second directional data relays 9A and 9B corresponding to the first and second head-direction detecting units 5A and 5B are included instead of the directional data relay 9 according to the second embodiment.

More specifically, according to the third embodiment, a highly responsive acceleration sensor is used for measuring the directions required for the arithmetic processing carried out by the displacement calculation unit 11. A magnetic sensor that does not generate drift is used for measuring the directions required for the image generating unit 4b of the computer 4 to generate an image.

More specifically, as illustrated in FIG. 9, the first head-direction detecting unit 5A is constituted by a magnetic sensor and outputs the detected directional data to the computer 4 via the first directional data relay 9A. The second head-direction detecting unit 5B is constituted by an acceleration sensor and outputs the detected directional data to the directional data storage unit 10 via the second directional data relay 9B.

According to the above-described structure, the second head-direction detecting unit 5B including a highly responsive acceleration sensor may be used as head-direction detecting means for detecting the directions required by the displacement calculation unit 11, and the first head-direction detecting unit 5A including a magnetic sensor that does not generate drift may be used as head-direction detecting means for detecting the directions required by the image generating unit 4b of the computer 4 to generate an image. Accordingly, operations may be carried so as to take advantage of the benefits of each sensor. In this way, the detection accuracy can be improved without using an expensive head-direction detecting sensor.

Other structures and operations of the head-mounted display system 1 according to the third embodiment are the same as those of the second embodiment.

(Advantages)

According to the third embodiment of the present invention, in addition to the advantages of the second embodiment, the detection accuracy can be improved without using an expensive head-direction detecting sensor, and the disorientation experienced by the user is greatly reduced.

### Fourth Embodiment

(Configuration and Operation)

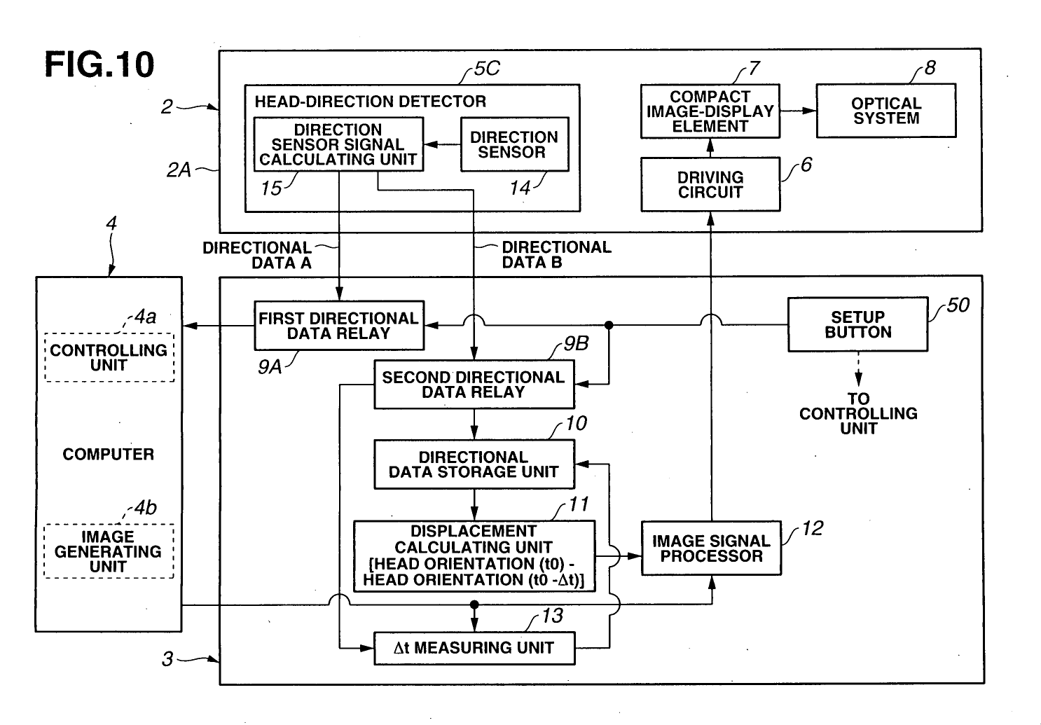

FIG. 10 illustrates a fourth embodiment of the head-mounted display system 1 according to the present invention and is a block diagram of the circuitry of the head-mounted display. The components included in FIG. 10 that are the same as those in the third embodiment are represented by the same reference numerals.

According to the fourth embodiment, one of the first and second head-direction detecting units 5A and 5B according to the third embodiment functioning as detecting means is replaced with a head-direction detecting unit 5C.

More specifically, as illustrated in FIG. 10, the head-direction detecting unit 5C comprises a directional sensor unit 14 including at least one sensor and a directional sensor signal calculating unit 15. The directional sensor unit 14 sends out a signal in accordance with the movement of the user's head to the directional sensor signal calculating unit 15. The directional sensor signal calculating unit 15 processes this signal to convert the signal into directional coordinates and then outputs directional data A and directional data B to a first directional data relay 9A and a second directional data relay 9B, respectively.

At this time, the directional sensor signal calculating unit 15 generates the directional data A and B in signal processing circuits or through arithmetic processing sequences. In other words, the directional data A is generated through a process focusing on preventing drift instead of focusing on response speed, and the directional data B is generated through a process focusing on increasing the response speed instead of focusing on preventing drift. The preferable response speed of the head-mounted display system 1 is to instantaneously display an image corresponding to the orientation of the user's head immediately after the sensor detects the movement of the user's head.

Accordingly, the preferable response speed is equal or lesser than a video rate. In other words, the time from the moment the movement of the user's head is detected to the moment the directional data B corresponding to the movement of the user's head is output should be, for example, 1/15 seconds or less or, and more preferably, 1/30 seconds or less.

The head-direction sensor signal calculating unit 15 includes signal processing means, such as low-pass filters (LPF), band-pass filters (BPF), or a noise filter having two different time constants, and the head-direction sensor signal calculating unit 15 outputs the directional data A and B in accordance with the time constants.

The signal processing means, such as LPF, BPF, or a noise filter may be provided as hardware or may be realized through arithmetic processing by software. Needless to say, the signal processing means may be any other type of signal processing circuit or arithmetic processing sequence so long as directional data A can be generated while focusing on preventing drift instead of focusing on improving the response time and the directional data B can be generated while focusing on improving the response time instead of focusing on preventing drift.

According to the above-described structure, by using the head-direction detecting unit 5C functioning as both the first and second head-direction detecting units 5A and 5B according to the third embodiment, the size and weight of the head-direction detecting unit 5C can be reduced. Moreover, the weight of the head-mounted display 2 may be reduced, and the usability of the head-mounted display 2 can be greatly improved.

The sensor included in the head-direction sensor unit 14 may be one of or a combination of an acceleration sensor, a gravity sensor, a magnetic sensor, or a geomagnetic sensor. Needless to say, this is also the same for the sensors of the head-direction detecting unit 5 and the first and second head-direction detecting units 5A and 5B, constituting the head-direction detecting means according to the first to third embodiments.

The structures of the head-mounted display system 1 for displaying a virtual floating image via the compact image-display element 7 and the optical system 8 for projecting a floating image of the HMD 2 according to first to fourth embodiments are described above. Although not depicted in the drawings, voice associated with the image may also be reproduced.

A structure wherein the directional data relay 9, the directional data storage unit 10, the displacement calculation unit 11, and the image signal processing unit 12 (including the Δt measuring unit) are included in the controller 3 is described above. The structure, however, is not limited to the above-described structure. In other words, when the main circuits are small and light-weight, these circuits may be included in the main body 2A of the HMD 2.

The present invention is not limited to the first to fourth embodiments and may be modified in various ways so long as the modification does not deviate from the scope of the present invention.

The head-mounted display system 1 according to the present invention may be effectively used as an image display system which adopts a head-mounted display (HMD), which includes a head tracker (HT) for detecting the orientation of a user's head, as a visual display apparatus of a virtual reality (VR) system or a mixed reality (MR) system. Moreover, the head-mounted display system 1 may be effectively used as an image display system in medical and academic fields in which VR systems and MR systems are expected to be put to practical use. The head-mounted display system 1 may also be effectively used as an image display system for recreational games. In particular, the head-mounted display system 1 is suitable for displaying images corresponding to the orientation of a user's head in real time while reducing the time lag caused by the arithmetic processing for generating an image carried out by a computer.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A head-mounted display system comprising:
display means freely detachable and attachable on a user's head;
direction-detecting means for detecting the orientation of a user's head in at least the horizontal direction, the direction-detecting means being disposed on the display means;
an image generator for generating an image in accordance with the orientation of the user's head detected by the direction-detecting means;
displacement-calculating means for calculating displacement, the displacement being the difference between directional data of the current orientation of the user's head detected by the direction-detecting means and directional data of the orientation of the user's head detected a predetermined amount of time ago; and
image-processing means for sending an image generated by the image generator to the display means after shifting the image in at least the horizontal direction in accordance with the displacement calculated by the displacement-calculating means.

2. A head-mounted display system comprising:
a display device freely detachable and attachable on a user's head;
a direction detector for detecting the orientation of the user's head in at least the horizontal direction, the direction detector being disposed on the display device;
an image generator for generating an image in accordance with the orientation of the user's head detected by the direction detector;
a displacement-calculating unit for calculating displacement, the displacement being the difference between directional data of the current orientation of the user's head detected by the direction detector and directional data of the orientation of the user's head detected a predetermined amount of time ago; and
an image processor for sending an image generated in the image generator to the display device after shifting the image in at least the horizontal direction in accordance with the displacement calculated by the displacement-calculating unit.

3. The head-mounted display system according to claim 1, further comprising a controller for controlling the display means, the controller including the displacement-calculating means and the image-processing means.

4. The head-mounted display system according to claim 1, wherein the direction-detecting means comprises a first direction-detecting unit and a second direction-detecting unit for detecting the orientation of the user's head, the first direction-detecting unit being capable of measuring the direction required for the displacement-calculating means to carry out calculations and the second direction-detecting unit being capable of measuring the direction required for the image generator to generate an image.

5. The head-mounted display system according to claim 1, wherein the image-processing means processes the image signal generated from the image generator to shift the floating image to be displayed on the display means in the horizontal direction.

6. The head-mounted display system according to claim 1, further comprising time-measuring means for measuring a predetermined amount of time, the predetermined amount of time being the amount of time required by the image generator to generate an image.

7. The head-mounted display system according to claim 6, wherein the time-measuring means measures the predetermined amount of time by sending out a dummy signal for notifying a change in the orientation of the user's head to the image generator and, analyzing the image signal generated, and thus measuring based on the signal the time required by the image generator to generate an image.

8. The head-mounted display system according to claim 6, wherein the time-measuring means measures the time required for generating a plurality of predetermined pattern images and determines it as the predetermined amount of time by statistically processing the time required for generating the plurality of predetermined pattern images.

9. The head-mounted display system according to claim 1, wherein the direction-detecting means generates directional data required for the displacement-calculating means to carry out calculations and directional data required for the image generator to generate an image.

10. The head-mounted display system according to claim 9, wherein the direction-detecting means comprises first signal-processing means for generating first directional data to be inputted to the displacement-calculating means and second processing means for generating second directional data to be inputted to the image generator.

11. The head-mounted display system according to claim 10, wherein the first signal-processing means is capable of carrying out processing at high response speed.

12. The head-mounted display system according to claim 11, wherein the response speed is equal to or faster than a video rate.

13. The head-mounted display system according to claim 11, wherein the response speed of the first signal-processing means is 1/15 seconds or less.

14. The head-mounted display system according to claim 10, wherein the second signal-processing means is capable of suppressing drift.

15. The head-mounted display system according to claim 2, further comprising a controller for controlling the display device, the controller containing the displacement-calculating unit and the image-processor.

16. A head-mounted display system comprising:
a display device freely detachable and attachable on a user's head;
a first direction detector and a second direction detector for detecting the orientation of the user's head in at least the horizontal direction, the first and second direction detectors being disposed on the display device;
an image generator for generating an image in accordance with the orientation of the user's head detected by the second direction detector;
a displacement-calculating unit for calculating displacement, the displacement being the difference between directional data of the current orientation of the user's head detected by the first direction detector and directional data of the orientation of the user's head detected a predetermined amount of time ago; and
an image processor for sending an image generated in the image generator to the display device after shifting the image in at least the horizontal direction in accordance with the displacement calculated by the displacement-calculating unit.

17. The head-mounted display system according to claim 2, wherein the image-processor processes the generated image signal from the image generator to shift the floating image to be displayed on the display device in the horizontal direction.

18. The head-mounted display system according to claim 2, further comprising a time-measuring unit for measuring a predetermined amount of time, the predetermined amount of time being the amount of time required by the image generator to generate an image.

19. The head-mounted display system according to claim 18, wherein the time-measuring unit measures the predetermined amount of time by sending out a dummy signal for notifying a change in the orientation of the user's head to the image generator and, analyzing the image signal generated, and thus measuring based on the signal the time required by the image generator to generate an image.

20. The head-mounted display system according to claim 18, wherein the time-measuring unit measures the time required for generating a plurality of predetermined pattern images and determines it as the predetermined amount of time by statistically processing the time required for generating the plurality of predetermined pattern images.

21. The head-mounted display system according to claim 2, wherein the direction detector includes a direction sensor and a signal processing unit for receiving an output from the direction sensor, the signal processing unit being capable of generating first directional data to be sent to the displacement-calculating unit and second directional data to be sent to the image generator.

22. The head-mounted display system according to claim 21, wherein the signal-processing unit includes first signal-processing means for generating the first directional data and second signal-processing means for generating the second directional data.

23. The head-mounted display system according to claim 22, wherein the first signal-processing means is capable of carrying out processing at high response speed.

24. The head-mounted display system according to claim 23, wherein the response speed is equal to or faster than a video rate.

25. The head-mounted display system according to claim 23, wherein the response speed of the first signal-processing means is 1/15 seconds or less.

26. The head-mounted display system according to claim 22, wherein the second signal-processing means is capable of suppressing drift.

27. A method for processing an image of a head-mounted display system, comprising steps of:
detecting the orientation of the user's head in at least the horizontal direction using direction-detecting means disposed on displaying means freely detachable and attachable on the user's head;
generating an image in accordance with the orientation of the user's head detected by the direction-detecting means;
calculating the displacement of the user's head, the displacement being the difference between directional data of the current orientation of the user's head detected by the direction-detecting means and directional data of the orientation of the user's head detected a predetermined amount of time ago;
processing the image such that the spatial position of displaying the generated image on the display means is shifted in at least the horizontal direction in accordance with the calculated displacement.

28. The method for processing an image of a head-mounted display system according to claim 27, wherein,
the direction-detecting means comprises a first direction-detecting unit and a second direction-detecting unit for detecting the orientation of the user's head, and
the step of detecting the orientation of the user's head includes steps of measuring the direction required for the first direction-detecting unit to calculate the displacement and of measuring the direction required for the second direction-detecting unit to generate an image.
